(19) United States
(12) Patent Application Publication
(10) Pub. No.: US 2026/0260210 A1
(43) Pub. Date: Sep. 3, 2026

(54) Method and System for Managing Inventory

(71) Applicant: Trade Capital Corporation, Menlo Park, CA (US)

(72) Inventors: Michael C. DORAN, Menlo Park, CA (US); Sanjay BONDE, Menlo Park, CA (US); Shiva SANDY, Reno, NV (US)

(21) Appl. No.: 19/653,197

(22) Filed: Apr. 21, 2026

Related U.S. Application Data
(63) Continuation-in-part of application No. 19/535,929, filed on Feb. 10, 2026.
Application No. 19/535,929 is a continuation of application No. 17/990,340, filed on Nov. 18, 2022, now Pat. No. 12,586,028.
(60) Provisional application No. 63/281,472, filed on Nov. 19, 2021.
(60) Provisional application No. 63/311,975, filed on Feb. 19, 2022.
(60) Provisional application No. 63/320,339, filed on Mar. 16, 2022.

(51) Int. Cl. G06Q 10/087

(52) U.S. Cl. CPC G06Q 10/087

(57) ABSTRACT

Systems and methods of managing inventory include a hybrid distributed computing system and database for recording title to the inventory in a third party after the inventory has been delivered to a location accessible to a producer (e.g., a user of the inventory). The cost and accounting of the inventory can then be managed separately from the physical possession of the inventory. The producer may then access and take title to the inventory on demand (as needed).

### RELATED APPLICATION DATA

This application is a continuation-in-part of U.S. Non Provisional application Ser. No. 19/535,929 filed Feb. 10, 2026, which is a continuation of U.S. Non-Provisional application Ser. No. 17/990,340 filed Nov. 18, 2022, which claims benefit of U.S. Provisional Application Ser. No. 63/320,339 filed Mar. 16, 2022, 63/311,975 filed Feb. 19, 2022, and 63/281,472 filed on Nov. 19, 2021, the entire disclosure of which is incorporated herein by reference.

### BACKGROUND

Holding inventory, such as physical goods, represents an undesirable financial burden. However, even companies practicing “just in time” inventories require some inventory on hand. Accordingly, manufacturers and other users of inventory must balance the need for having inventory on hand against the adverse impact on a company's financial standing and its balance sheet. OEMs, Suppliers and Contract Manufacturers try to push inventories to each other, and it is therefore a cause of friction for effective collaboration amongst these parties.

Conventional inventory management methods include optimizing inventory levels, lead times and critical last-minute scheduling of goods delivery, such approaches minimize inventory carrying costs at the expense of greater supply chain risk and resiliency due to unreasonably lower inventory levels or delayed cashflow to suppliers.

### SUMMARY OF THE INVENTION

The disclosed implementations include automated systems and methods of managing inventory whereby title to inventory (e.g., physical goods, virtual assets, or digital assets) needed by a producer (i.e. an entity desiring to modify, sell, distribute, or otherwise use the inventory) is recorded as being held by a third-party entity that is not the supplier of the goods or the producer, while at the same time allowing the goods to be physically present at a desired location under control of the producer. Transfer of title to the producer is then automatically recorded in a database. Title can be transferred to the producer upon the occurrence of one or more specified conditions. The transfer can be accomplished using one or more smart contracts executing in a decentralized computing environment, such as a blockchain. Further, the financial transactions associated with the transfer of the inventory can be accomplished in a seamless and efficient manner.

A first aspect of the invention is an inventory management system comprising: a data storage device configured to store inventory data including a recordation of title of specific inventory and a status of the inventory; a request module configured to receive a request for the specific inventory from a producer, the request including instructions for delivery of the specific inventory to a location accessible by the producer; a purchase order (PO) generation module configured to, in response to the request for the specific inventory, generate a purchase order for purchase of the specific inventory from a supplier, wherein the purchase order specifies delivery of the specific inventory to the location accessible to the producer and wherein the purchase order species transfer of title in the specific inventory to a title holder that is an entity different from the producer; an inventory management contract module configured to generate an inventory management contract, corresponding to the specific inventory, between the producer and the title holder, the inventory management contract specifying a fee payable to the title holder for holding title to the specific inventory and conditions upon which title of the specific inventory will transfer from the title holder to the producer; an inventory tracking module configured to track the specific inventory and to update status of the specific inventory in the inventory data, the status of the specific inventory being recorded in the inventory data as conditionally on-hand inventory of the producer while title of the specific inventory is recorded in the inventory data as being held by the title holder and the status of the specific inventory being recorded in the inventory data as on hand when title in the specific inventory is recorded in the inventory data as being held by the producer; and a title transfer module configured to transfer title of the specific inventory from the title holder to the producer, in response to satisfaction of at least one condition specified in the inventory management contract, by recording title of the specific inventory in the inventory data as being held by the producer at a time after the specific inventory has been stored at the location accessible to the producer and in response to satisfaction of the at least one condition.

### BRIEF DESCRIPTION OF THE DRAWINGS

The foregoing summary, as well as the following detailed description, will be better understood when read in conjunction with the appended drawings. For the purpose of illustrating the invention, there are shown in the appended drawings various illustrative implementations. It should be understood, however, that the invention is not limited to the precise arrangements and instrumentalities shown.

FIG. 1 is a block diagram of an architecture of an automated inventory management system in accordance with disclosed implementations.

FIG. 2 is a flow chart of a method of automated inventory management in accordance with disclosed implementations.

FIG. 3. is a flow diagram of documents and goods in accordance with an example of disclosed implementations.

FIG. 4A is an architecture diagram of a decentralized marketplace for inventory discovery and matching in accordance with disclosed implementations.

FIG. 4B is a flowchart of a method for inventory discovery and matching in accordance with disclosed implementations.

FIG. 5A is an architecture diagram of a system for competitive finance and bidding in accordance with disclosed implementations.

FIG. 5B is a flowchart of a method for competitive finance and bidding in accordance with disclosed implementations.

FIG. 6A is an architecture diagram of a system including a smart contract-based identity and settlement layer.

FIG. 6B is a flow chart of a method for implementation a smart contract based identity and settlement layer.

FIG. 7A is an architecture diagram of a blockchain tokenization and title transfer system in accordance with disclosed implementations.

FIG. 7B is a flowchart of a method for blockchain tokenization and title transfer in accordance with disclosed implementations.

FIG. 8A is an architecture diagram of a system using asset-backed cryptocurrency and liquidity pools in accordance with disclosed implementations.

FIG. 8B is a flowchart of a method for creating financial instruments using asset-backed cryptocurrency and liquidity pools in accordance with disclosed implementations.

FIG. 9A is an architecture diagram of a system for purchase order tokenization and B2B settlement in accordance with disclosed implementations.

FIG. 9B is a flowchart of a method for purchase order tokenization and B2B settlement in accordance with disclosed implementations.

### DETAILED DESCRIPTION

The systems and methods disclosed herein allow for delivery of inventory, such as goods, to an area in control of a producer prior to transferring title in the inventory to the producer, thus achieving advantages of just in time inventory while avoiding many of the disadvantages of conventional inventory management methods. The disclosed implementations allow for unconstrained holding of inventories to mitigate both risks and costs. Using smart contracts executed on a decentralized computing environment, more optimal cost distribution is achieved, and risk is reduced. The novel architecture and database model of disclosed implementation allows the financial burden of carrying inventory to be separated from the inventory itself, creating a marketable and financeable derivative as a secondary advantage. Such advantages are achieved using novel inventory management logic, data models, and devices, as described in detail below.

The system and methods described herein may be used in transactions involving two, three or more parties. In an illustrative example, three parties are involved. These parties are referred to herein as a “producer,” a “supplier” and a “title holder” (also referred to as the “inventory management system” or “system”). The producer is a party that receives inventory from a supplier for the purpose of using the inventory to produce additional goods, to sell goods, to provide a service, and/or otherwise consume the inventory. The supplier is a party that provides the inventory to the producer. As an example, the supplier may be an original equipment manufacturer (OEM), or an intermediate producer in a supply chain. The title holder is a party that is distinct from the producer and which holds title to inventory for a period of time after the inventory has been delivered to a location accessible to the producer and until specified conditions are met indicating that the producer is ready to use the inventory at which time the system automatically transfers title to the producer. The title holder typically takes title from the supplier. The title holder is typically a third party and may be the manager of, or a subscriber to, the inventory management system. Alternatively, the role of “title holder” can be performed by the “supplier.” Accordingly, the title holder can be a party controlling the inventory management system or can be another designated party.

In an exemplary use case, the producer will determine a future need for inventory (e.g., goods), the producer will send a request for this inventory to the supplier and/or the title holder. The title holder generates a purchase order that transfers title of the inventory from the supplier to the title holder and requests that the inventory be delivered to a location accessible to the producer. When conditions indicate that the producer is ready to use the inventory, the title holder/system is notified, and the system transfers title to the producer (and can make payment for the inventory to the title holder). Notice of the conditions can be automatically generated by tracking conditions of the inventory, such as movement of the inventory from the location accessible to the producer to, for example, a production floor. The title transfer and payment can be affected by logic recorded in one or more smart contracts executing on the decentralized environment. In this process, the producer avoids taking title to the inventory until needed, while at the same time, the inventory is positioned in a convenient location under control of the producer and can be considered as “on-hand” inventory.

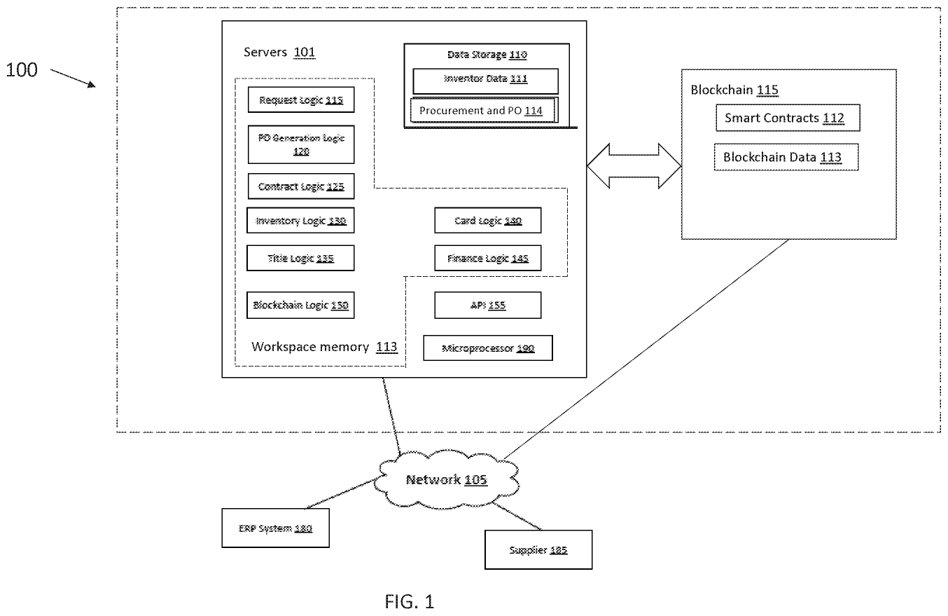

FIG. 1 illustrates a computer architecture of automated inventory management system 100 in accordance with disclosed implementations. Inventory Management System 100 may be embodied in a single computing device or a network of connected computing devices using software to execute the logic described herein. The logic is described herein as corresponding to “modules”, i.e., code executed by one or more computer processors. The modules are segregated by function but need not correspond to any specific discrete code segment(s) and/or processor(s). Inventory Management System 100 is distinguished, in part, by elements configured for designating and transferring title to inventory separately from the physical possession of the inventory. For example, a producer may need inventory to produce a product, physical or digital, then using inventory management system 100, may take physical possession of the inventory prior to taking title to the inventory. Title is optionally held by a third party title holder until the inventory is needed to be utilized by the producer.

Inventory management system 100 includes server(s) 101 having data storage 110. Data storage 110 is configured to store at least inventory data 111 (described in more detail below). Procurement and purchase order data 114, indicating various procurement information, sales information, pricing, libraries of goods and specifications, maximum and minimum future sales dates and/or the like, can also be stored in data storage 110. Inventory management system 100 also includes a decentralized network, blockchain 115 in this implementation. Blockchain 115 has smart contracts 112 stored thereon for execution. Blockchain 115 also stores and blockchain data 113, such as transaction data described below. Executable computer code, representing any of the executable logic/modules discussed herein can be stored in workspace memory 113 of server(s) 101.

Inventory data 111 applies a novel data model that distinguishes between on-hand inventory in which the producer has title and on-hand inventory in which the producer does not have title but for which the producer has future rights and obligations. Inventory in which the producer does not have title but for which the producer has future rights and obligations is referred to herein as “conditionally on-hand” inventory. The storage of the inventory data 111 or the logic may be stored on premise or may be on cloud or on distributed computing systems operating together in unison or under a common command structure. Further, inventory data 111 can be stored on blockchain 115 as part of blockchain data 113. Inventory data 111 may be expanded and/or updated over time based on the occurrence of events or transactions associated with inventory and stored accordingly for ease of retrieval.

In some implementations, the data is further enhanced by the capabilities of intelligent process automation to learn and preconfigure repetitive tasks, e.g., automated or non-automated tagging. In some implementations, the data stored in data storage 110 and/or blockchain 115 is optionally collected over 5G+ networks using IOT devices to offer near real time data and inventory tracking. In some implementations, data storage 110 is further enhanced by the capabilities of big data management to analyze trends and offer predictions, outliers and other relevant inferences for the management of inventories and title and manage cyber security risks, e.g., the addition of master data and/or metadata elements targeted to enrich and enhance the capabilities of the data storage 110.

Request logic module 115 is configured to receive a request for immediate or future acceptance of specific inventory, such as designated physical goods, from a producer under a master contract. This request can include any combination of quantity, date, price and terms, specifications, shipping conditions, and/or delivery of the inventory to a location accessible to the producer. The master contract can be a legal contract and can have a logical corollary recorded as one of smart contracts 112. Such requests for specific inventory may be sent and received electronically or physically. The location accessible to the producer can be a physically secured location or container, optionally monitored by an access device configured to detect access to the inventory and to communicate this access to title logic module 155 disclosed in detail below. Title logic module 155 can be configured to generate access credentials to the physically secured location or container.

As used herein “location accessible to the producer” refers to a location from which the producer can readily retrieve inventory, e.g., a warehouse or container in control of the producer and proximate to a manufacturing facility at which the inventory is consumed. The location accessible to the producer can be a location owned and operated by the producer or by a contracted party holding physical custody of the inventory on behalf of the producer. For example, a location accessible to a producer may be a warehouse from which the producer can retrieve truckloads or pallets of inventory during a day's production run. The location accessible to a producer may be located on a production floor. A location accessible to a producer is generally more conveniently accessible to the producer than an original source of the inventory. Inventory is stored at the location accessible to the producer while it is recorded as conditionally on-hand until needed by the producer at which time the inventory can be recorded as on-hand.

In some implementations, request logic 115 is further configured to generate specifications of terms of a purchase of the inventory, including any combination of: a quantity, a part number, a price, payment terms, an interest rate, a fee for holding title to the inventory, an identifier of the location accessible to the producer, and a maximum holding period in which the title holder will hold title to the inventory. These specifications can be used in one or more of smart contracts 112, to control ownership of the inventory based on various conditions in the manner set for the below.

In some implementations, request logic 115 is further enhanced by the capabilities of intelligent process automation to learn and preconfigure repetitive tasks, e.g., forecasting and auto population of purchase or sales orders, detection of outliers and alerts thereto, and population of recommendations. In some implementations, request logic 115 is configured to assure that the request for inventory includes terms and conditions allowed or required by the supplier on a pre-agreed basis pursuant to contract logic 125 below. The terms and conditions can be enforced by one or more of smart contracts 112.

In some implementations, request logic 115 is further enhanced by the capabilities of quantum computing for the purpose of handle operations at speeds substantially higher than conventional computers. Request logic 115 can be executed by a cloud computing platform for the purpose of offering, amongst other benefits, scalability back-up and restore functions, improved collaboration, accessibility, lower maintenance cost, high response, use of mobility devices, services in a pay-per-use model, substantial data storage capacity and data security. Request logic 115 can be configured to allow users to make requests using their mobile devices. This implementation will leverage PO generation logic 120 and inventory card logic 140 (described below) to facilitate secure encrypted transactions with inherent limits.

As noted above, generally, the three parties involved in purchase order generation are (a) producer; (b) title holder or prospective title holder; and (c) supplier. Purchase order (PO) generation logic 120 is configured for use by a prospective title holder to automatically import, from a producer, requisite purchasing and contractual data necessary to generate a purchase order for purchase of the inventory from a supplier based on producer requests received from Request logic 115 and enforced by one or more of smart contracts 112 for further execution. The purchase order can require delivery of the inventory to the location accessible to the producer; and/or automatic pre-population of purchase order information by usage of data from producers ERP system 180 and strategic procurement systems. In some implementations, PO generation logic 120 automatically uploads and updates 3PL and shipping contracts associated with a PO for tracking of physical inventories from dispatch by a supplier 185 until future purchase by producer, onto blockchain logic 150, which provides a node on blockchain 115. Producers, suppliers, title holders and other parties can also execute a node on blockchain 115 to share various data. PO generation logic 120 can be further enhanced by the capabilities of intelligent process automation to learn and preconfigure repetitive tasks, e.g., forecasting and auto population of purchase or sales orders, detection of outliers, and intelligent recommendations.

In some implementations, the purchase order requires payment for the inventory to be made by the title holder to the supplier on terms imported from producer requests into a smart contract which designates the title holder as owner of the inventory as of delivery or shipment of the inventory to the location accessible by the producer. Wherein a first right for purchase of the inventory by the producer is granted and recorded. After issuance of the purchase order, associated data is stored in the data storage 110 and/or as blockchain data 113 with further addition of data related to financing of the inventory purchase and recording of insurances, liens, and rights related to return of inventory to suppliers.

Contract logic 125 is configured to generate an inventory management contract between the producer and the title holder. The inventory management contract can specify terms, including a fee for holding title to the inventory and a designation of the location accessible to the producer. The inventory management contract can be enforced by one or more of smart contracts 112 executed on blockchain 115 automatically in response to satisfaction of a condition, for example, passage of a designated maximum hold time for which the title holder is required to hold title to the inventory, the producer accessing the location accessible to the producer, removal of the inventory from the location accessible to the producer, and/or receipt of a purchase order for the inventory.

In some implementations, contract logic 125 is further configured to execute an insurance contract configured to assure that the producer will perform under the contract. Contract logic 125 can specify liens, UCC registrations, cost allocations, rights and responsibilities for safeguarding of inventory and purchase terms including but not limited to pricing, payment currency including crypto currency and other terms agreed by the producer for future purchase of the inventory as set in request logic 115. Optionally, contract terms can be enforced by one or more of smart contracts 112.

Contract logic 125 can also be configured to generate an Inventory Handling and Safekeeping Contract (IHSC) between the titleholder and producer or producer's designee to manage inventories on behalf of title holder for a fee. The IHSC can specify service terms including producer's obligations, fees for managing inventories pursuant to any service level agreements, and obligations of the producer on reporting on inventory status, real-time or otherwise, and all data associated with inventory pursuant to request logic 115.

Inventory logic 130 can be configured to track inventory on-hand, real-time or otherwise, for the producer and to update the inventory data, the specific inventory being listed as conditionally on-hand inventory of the producer while title of the inventory is held by the title holder. In some implementations, inventory logic 130 is configured to specify first right of use of conditionally on-hand inventory by producer and store the same on blockchain logic module 115 and blockchain data 113. Inventory logic module 130 can be further enhanced by the capabilities of intelligent process automation to learn and preconfigure repetitive tasks e.g. forecasting and auto population of purchase or sales orders, detection of outliers, intelligent recommendations. Inventory logic module 130 can also be further enhanced by the capabilities of human augmentation to automatically collect data related to any physical movement of inventories, e.g., forecasting and auto population of purchase or sales orders, detection of outliers and alerts thereto, and population of recommendations.

In some implementations, Inventory logic 130 is executed over 5G+ networks using IOT devices to offer near real time data tracking, e.g., forecasting and auto population of purchase or sales orders, detection of outliers and alerts thereto, and population of recommendations. Further, inventory logic 130 can be configured to change a designation of inventory from conditionally on-hand to on-hand responsive to the transfer of title of the inventory. This change can be recorded as a transaction on blockchain 115. Inventory logic 130 may be inserted onto smart contracts and associated blockchains to host contract logic 125 and execute PO Generation logic 120. Inventory logic 130 can be configured to allow for system generated alerts to be generated and communicated to users.

Title logic 135 is configured to transfer title of the inventory from the title holder to the producer at some time after the inventory have been stored at the location accessible to the producer, the title transfer being initiated in response to satisfaction of a condition, e.g., a pull order received from the producer or an automated sales order issued by the title holder. The title transfer can be performed according to the inventory logic 130, and request logic 115. Title logic 135 can be configured to process payment terms for the inventory from the producer to the title holder, optionally automatically according to the inventory management contract commonly called a vender managed inventory contract, automatic filing of UCC filings, related changes in security interests and liens, producer's rights for return of inventory, automatic confirmation of amounts due and payable by the producer. In some implementations, title logic 135 is executed over 5G+ networks using IOT devices to offer near real time data tracking optionally using Intelligent Process Automation, RFID tags, and/or other software to track physical movement of inventory.

Card logic 150 is configured to allow financial purchasing power to purchasing agents of the requester, individually or in aggregate, based on an overall financial limit set by the title holder in contrast to a credit card, where a user can immediately purchase assets against which a liability is simultaneously created, or a debit card where a user can purchase by simultaneous use of a current cash or other asset balance. Inventory card logic 130 is configured to distribute multiple inventory purchasing inventory cards associated with a master financial account to a number of purchasing agents, each Inventory card representing the limits on purchases that can be made by each of the purchasing agents. Inventory card logic 130 can capture financial considerations associated with the purchase of the inventory, title, asset values and description, related obligations and liabilities associated with specific contract terms and/or limits and generate automated reports and statements thereof at set period of time indicating balances outstanding and settled. Further, inventory card logic 130 can also generate a physical/digital label for the inventory at the location of the requester. The physical label for the inventory can be configured for placement at the location accessible to the producer, the physical label optionally including a printed label or an electronic label, and any combination of the title holder of the inventory, an identifier of the inventory, a use-by date for the inventory, a description of the inventory, and an inventory entry for the inventory. Inventory card logic 130 can be configured to associate a physical or virtual card with the inventory, the inventory card optionally being associated with a specific inventory management contract and/or purchasing agent. The inventory card can be associated with specific contract terms and/or limits. Inventory card logic 130 is optionally configured to set the fee for holding the inventory based on a level of risk associated with the producer, and optionally configured to calculate a credit rating for a particular purchase of inventory. In some implementations, inventory card logic 130 is configured to generate and/or distribute the inventory cards responsive to a master contract between the producer and the title holder pursuant to contract logic 125.

Finance logic 145 is configured to receive offers to fund purchase of the inventory by the title holder and executed by inventory card logic 140 pursuant to contract logic 125. In some implementations, finance logic 145 is configured to accept the offers to fund purchase of the inventory, optionally from among multiple offers, and is optionally configured to bundle interests in fees charged for holding title to inventory for sale to investors. Further, finance logic 145 can be configured to accept all currencies, including cryptocurrencies and fiat currencies, to enable purchase of the inventory, optionally from among multiple currencies. Finance logic 145 can also be configured to bundle interest in fees charged based on variable interest rates such as LIBOR and Prime.

Finance logic 145 can be configured to accept fixed fees in lieu of variable rates and optionally providing for the reconciliation and balances due or recoverable based on such reconciliation and generate automated reports and statements thereof at set period of time indicating balances outstanding and settled as PPV. In some implementations, finance logic 145 is further enhanced by the capabilities of intelligent process automation to learn and preconfigure repetitive tasks. Finance logic 145 can be configured to associate each inventory item held against its financier and cause a lien in favor of that financier to be recorded automatically pursuant to title logic 135.

Finance logic 145 can also be configured to Increase/optimize Return on Capital Employed (ROCE), a conventional financial ratio that can be used to assess a company's profitability and capital efficiency, by reducing working capital funding or its cost by leveraging the machine learning in data storage 110 combined with the analytics of request logic 115 and the intelligence automation of inventory logic 130. In some implementations, finance logic 145 is configured to enhance/optimize liquidity by reducing working capital funding or its cost at the same level of working capital funding cost by leveraging the machine learning in data storage 110 combined with the analytics of request logic 115 and the intelligence automation of inventory logic 130. Finance logic 145 can be further configured to optimize overall cost by reducing working capital funding by leveraging the machine learning in data storage 110 combined with the analytics of request logic 115 and the intelligence automation of inventory logic 130.

Blockchain logic 150 includes node protocol software to execute a node on blockchain 115 (to interface server(s) 101 with blockchain 115) and can be configured to record ownership transfer associated with the origination of ownership of the inventory and the title transfer from the title holder to the purchaser as a transaction on blockchain 115. In some implementations, blockchain logic 150 is configured to store a record of any combination of: title to the inventory, contract terms (e.g., fees, prices, maximum hold times, currencies, payment terms), location of the inventory, and shipping data, tracking numbers, delivery events, pull requests, inventory returns, liens, financier details and all associated terms in a smart contract to enforce compliance of contractual obligations. Blockchain logic 150 can be further enhanced by the capabilities of Intelligent Process Automation to learn and preconfigure repetitive tasks. Blockchain logic 150 can be executed as part of a decentralized computing environment over cloud computing for the purpose of offering, amongst other benefits, back-up and restore functions, improved collaboration, accessibility, lower maintenance cost, use of mobility devices, services in the pay-per-use model, substantial data storage capacity and data security.

Application programing interface (API) logic 155 is configured to receive the request for inventory from an ERP (enterprise resource planning) system 180 for the use by title holder to purchase inventory pursuant to contract logic 125. Microprocessor 190 includes one or more hardware computer processor(s) configured to execute at least the instructions of all logic elements described herein. Microprocessor 190 can include electronic, optical, or quantum computing circuits.

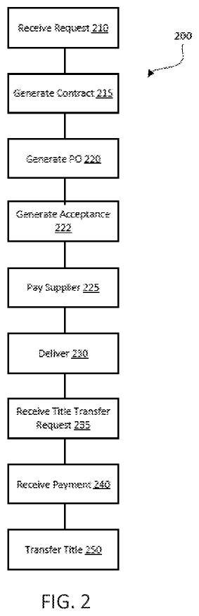

FIG. 2 illustrates method 200 of managing title to inventory, according to various implementations of the invention. Method 200 can be accomplished by the computing environment of FIG. 1. Title holder purchases, pays for, and holds title to inventory based on purchase intents previously issued by a producer that detail specifications and terms and conditions for such purchase. Inventory may optionally be located close to a producer or contract manufacturer, and in some case collocated with them in a clearly marked and segregated location within the premises under control of the title holder. The producer or contract manufacturer has visibility to the inventory specifications and quantity available and can pull (i.e., purchase) via pull order any items from the inventory as needed to support producers manufacturing operations. Purchasers optionally issue a PO to the title holder and/or the title holder may issue a sales order to the producer for such items pulled.

All purchases of inventory items by title holder shall be pursuant to a master contract between title holder and the producer and optionally a supplier (185 of FIG. 1) from whom such items are to be purchased. Such contract shall specify the amount of inventory that may be purchased and held by title holder at any time, the list of authorized components, pricing terms and related authorized suppliers including supply locations if relevant.

A purchase order to a supplier is generated by, for example, the title holder placing a purchase order directly with the supplier stipulating that the Bill-To-Party (the party to be billed) shall be the title holder, and listing the item(s), quantity(s), price, ship-to-location, shipping incoterms, shipping date. Confirmation and change orders prior to order fulfillment and shipment shall be negotiated directly between the title holder with the Supplier based on terms agreed between the producer and the supplier. Title holder shall relay the received notifications to the producer and vice versa.

A Supplier Advanced Ship Notices (ASN) shall be relayed to and made visible to the title holder, the producer, and any logistics provider(s). To achieve this visibility, the supplier sends the ASN to the logistics provider who then forwards a copy to title holder or the supplier sends the ASN to the title holder who then forwards a copy to logistics company and the producer. Verification of receipt of inventory shall be conducted by the title holder or its agent who could be the logistics provider or the producer. Such agent will certify that inventory is received in good condition and that the ASN details are accurate. Release of payment to supplier by the title holder shall be conducted thereafter upon agreed terms and conditions.

Conditions, such as a Pull of inventory shall trigger an invoice from the title holder to the producer and inventory shall be depleted in the title holders accounting records and an appropriate amount receivable from the producer shall be recorded. IN other words, title of the specific is transferred to the producer and the status of the changed from conditionally on-hand to on-hand. Thereafter the producer will make payment to title holder on agreed terms.

Referring to FIG. 2, at step 210 a request is configured in producer's IT systems to issue automated procurement instructions, i.e., requests, for certain inventory from the title holder at a prescribed date and simultaneously log all transaction details over block chain logic 150 and report the same to data storage 110. Such requests may be altered by the producer on pre-agreed terms and optionally issue a fresh set of instructions.

At step 215 a contract is generated between the producer and a title holder, the contract specifying any combination of the following: that the title holder will hold title to the inventory until a request or notice for the inventory is received by the title holder from the producer, a maximum hold time is reached, the producer accesses the inventory and optionally will purchase the inventory from the title holder in the future, terms (i.e., a specified condition is satisfied), conditions, purchase obligations associated with the future purchase obligation of the producer, automated sales, transfers, scrapping and return rights. Such contract details can be recorded on block chain logic 150 and/or data storage 110. The title holder may optionally issue the producer and/or its agents an inventory card setting privileges to the producer and/or its agents the ability to issue, to a title holder, procurement intents for inventory.

At step 220, a purchase order for the inventory is generated and transmitted to a specified supplier of the inventory together with inventory specifications based on step 210. The purchase order is optionally generated by the title holder and delivered to the supplier. The PO is optionally automatically generated and configured in title holders IT systems to replicate procurement instructions from producer for certain inventory or materials and simultaneously logged over block chain logic 150 and report onto data storage 110. The purchase order is typically subject to the terms of the contract generated in step 215.

At step 222, the inventory is accepted upon meeting specifications set in step 220, or rejected if they do not meet the specifications. An acceptance or rejection order can be transmitted to a supplier of the inventory and simultaneously recorded as a transaction on blockchain 115, by block chain logic 150, and/or data storage 110. Verification of inventory can be conducted by the title holder or its agent who could be the logistics provider or the producer.

At step 225, title holder or its agent will certify that inventory is received in good condition and that the ASN details are accurate, and payment will be released to the supplier by the title holder thereafter upon agreed terms and conditions. Optionally this may be affected by generating a wire instruction or any other form of payment instructions to the title-holders bank for the payment of inventory ordered by title-holder pursuant to step 225, transmitting or supplying the payment instruction based on inventory acceptance at step 222 and simultaneously recording the same on blockchain 150 and/or transmitted to data storage 110.

At step 230, the title holder may receive title to the inventory upon shipment by the supplier or on acceptance of delivery according to the terms and conditions prescribed in the purchase order or as set in a purchase contract. For example, the condition triggering the title transfer may be that the inventory is moved to a location accessible to the producer upon completion of step 222. This step can include generating an inventory warehouse label with title holder's details labeled for distinguishing between producer-owned (on-hand) and title holder owned (conditionally on-hand) inventory and simultaneously recording the label as a transaction on blockchain 115 and/or data storage 110.

At step 235, the title holder receives a request to transfer title of the inventory to the producer, optionally while the inventory is located in the location accessible to the producer or the producer is in physical possession of the inventory. For example, the producer may request title to the (conditionally on-hand) inventory that they intend to use on a particular day or a particular production run. In some implementations, a title transfer request is automatically generated by detection of removal of the inventory from the secure location accessible to the producer. For example, inventory may be detected as having been removed visually or using a tracking technology such as RFID or barcodes.

The producer has visibility to the inventory specifications and quantity available and can pull (i.e., purchase) via pull order any items from the inventory as needed to support producers manufacturing operations. Optionally this may be affected by configuring a Pull Ordering System in producers ERP or IT system for ordering of inventory or materials from title holder over an inventory replacement system that is used by to replenish their inventory levels and simultaneously recorded on block chain logic 150 and/or data storage 110.

At step 240, the title holder receives payment from the producer for purchase of the inventory from the title holder on terms set in producers purchase order, which can include a fee for holding title to the inventory. This can be simultaneously recorded as a transaction on block chain logic 150 and/or data storage 110. At step 250, the producer or CM pull of inventory triggers an invoice from the title holder to the producer or CM and inventory is depleted in the title holders accounting records transferring title of the inventory to the producer. Simultaneously, based on the pre-agreed terms of sale, an amount receivable from the producer is recorded. Thus, completing the transfer of title to the inventory from the title holder to the producer.

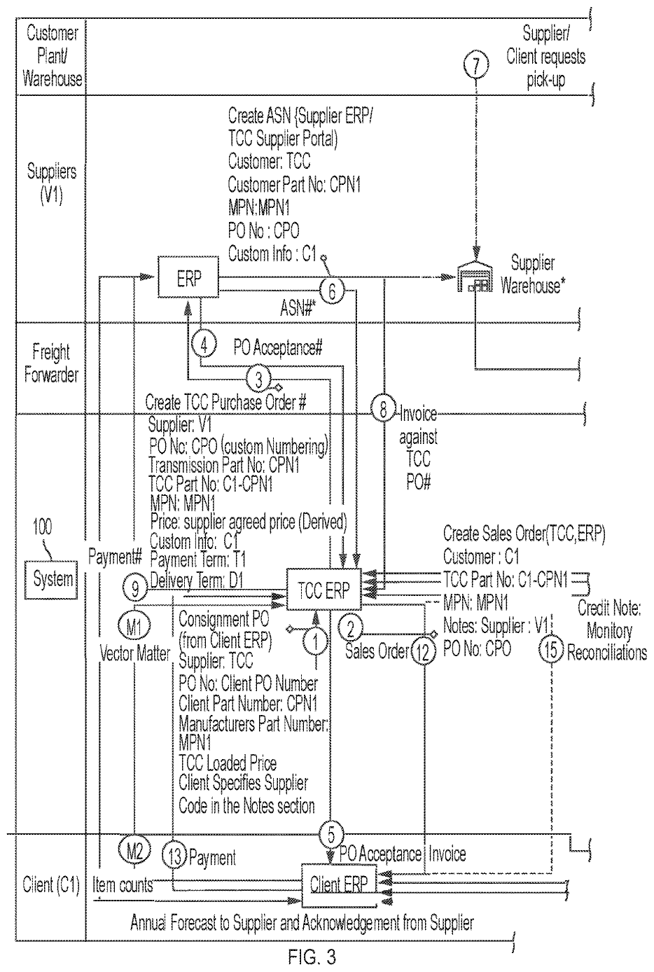

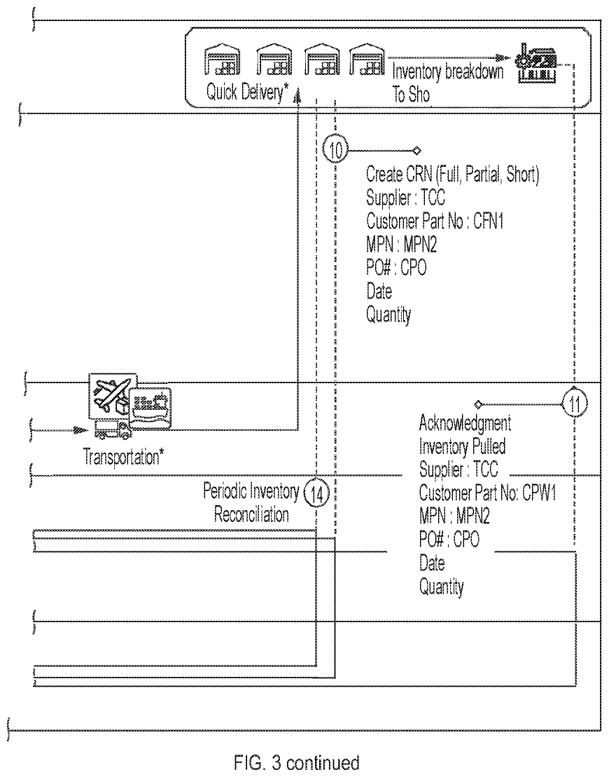

FIG. 3 illustrates the flow of inventory and transaction documents in greater detail in accordance with an example of disclosed implementations. Table 1 below describes the workflow at each labeled step of FIG. 3. In FIG. 3, an asterisk (*) indicates a track and trace point for collecting and reporting data to the appropriate parties and a hash mark (#) indicates that a supplier communication is shared with the client/customer. Further, M1 and M2 of FIG. 3 are master data documents representing ongoing vendor information, inventory information, agreed supplier price and system 100 marked up price synced between an ERP of system 100 and the client.

TABLE 1

| Step | Document | Description |
|---|---|---|
| 1 | Consignment PO | The client issues a consignment PO to System 100 (FIG. 1). The |
| | | consignment PO specifies the supplier of the inventory along |
| | | with other material information, such as delivery schedule and |
| | | location, and business terms between the client and system 100. |
| | | The item price is considered as system 100 “loaded” price which |
| | | will be reflected on final invoice (see below) from system 100 |
| | | which will be paid by the client. |
| | | PO data, and other data herein, can be shared with system 100 |
| | | through any conventional channel such as email, a Supplier |
| | | Portal, EDI or flat file exchange. Alternatively, any information |
| | | can be conveyed to relevant parties by being recorded on the |
| | | blockchain of system 100 and made available to blockchain |
| | | nodes of the parties. |
| 2 | Sales Order | A sales order is generated in the by system 100 based on the |
| | | information in the consignment PO. The specific inventory is a |
| | | unique item in system 100. For example, the inventory can be |
| | | tokenized and recorded on the blockchain of system 100. |
| 3 | Purchase Order | Based on the sales order a final PO is created and sent to the |
| | | designated supplier. The client PO number of the consignment |
| | | PO can be maintained as final PO number. The item price is |
| | | reflected as the agreed price between the client and the |
| | | supplier. |
| 4 | PO Acceptance | The supplier conveys acceptance of the final purchase order. Any |
| | | changes to delivery quantity or dates (if any) are recorded in the |
| | | blockchain or other data storage of system 100. |
| 5 | PO Acceptance | Transparent visibility of the “agreed” supplier schedule is |
| | | provided by system 100 to the client. |
| 6 | ASN | Once the material is ready for shipment, the supplier provides |
| | | Advance Shipment Notification (ASN) to system 100. And this is |
| | | made available to the client. |
| 7 | Supplier Shipment | The supplier requests the client transportation provider for the |
| | | material pick-up. The material is picked up by the transporter. |
| | | Inventory title is recorded as owned by system 100 at this time |
| | | until sometime in the future when specified conditions are |
| | | satisfied. System 100 captures “Track & Trace” information from |
| | | the transporter and provides visibility thereof to the client. |
| 8 | Supplier Invoice | The supplier submits an invoice to system 100 which is recorded |
| | | in system 100 |
| 9 | Supplier Payment | Based on the agreed payment terms between the client and |
| | | supplier, system 100 issues payment to the supplier which is |
| | | recorded in system 100. |
| 10 | Material Receipt | Material receipt at the client warehouse is recorded by the client |
| | | and the storage location information is shared with system 100. |
| 11 | Inventory Drawdown | The client pulls the inventory from the consigned location for |
| | | consumption and the system 100 is notified. Assuming that this |
| | | is the condition precedent for transfer of ownership, inventory |
| | | title is recorded as being to the client, i.e. the title to the |
| | | inventory is transferred to the client. |
| 12 | Customer Invoice | Inventory pulled by the client is eligible for invoicing. |
| | | The system 100 generates a customer invoice shares the same |
| | | with the client. |
| 13 | Payment | Based on the agreed terms the client issues the payment to |
| | | system 100 which are recorded in the system 100. |
| 14 | Inventory Reconciliation | Periodically, inventory at the client location under title of system |
| | | 100 are physically verified and reconciled in system 100. |
| | | Adjustments are recorded and reconciled with the client. |
| 15 | Credit note | A variance report is generated on a periodic basis and a credit |
| | | note is issued by the system 100 to the client for any purchase |
| | | price variance (PPV). |

Several implementations are specifically illustrated and/or described herein. However, it will be appreciated that modifications and variations are covered by the above teachings and within the scope of the appended claims without departing from the spirit and intended scope thereof. For example, while the term “producer” is used herein as a way of example, this term is meant to include any holder of inventory/materials used to manufacture inventory. It is further intended to include a user, assembler, producer, packager, and/or modifier of inventory. For example, the term producer may apply to a party that assembles or modifies parts produced by others, or that consumes good for the provision of a service. The term “producer” may apply to an airline that uses inventory assets (e.g., aircraft and crew and aviation fuel) to provide a transport service. Further, the systems and methods described herein may be applied to any holder of inventory and/or resources for the purposes of manufacture, sale and/or distribution of inventory to other parties; or providers of services requiring inventory or assets. The systems and methods discussed herein may further be applied to sub-assemblies of parts. For example, a producer may produce a sub-assembly and transfer title of the sub-assembly until the sub-assembly is need for further assembly or use, at which time title is transferred back. In this case the producer may also take the role of a supplier. In some implementations, the systems and methods described herein are used by more than three parties in a supply chain. For example, a first supplier may provide inventory to a first producer who is a second supplier to a second producer. The first producer/second supplier uses inventory received from the first supplier to produce inventory that are then passed on to the second producer for use. In such situations, title may be held by a title holder though more than one step in the supply chain, e.g., the first producer may not ever take title in the inventory provided by the first supplier and title only transferred from the title holder upon use of the (possibly improved inventory) by the second producer.

The systems and methods described above may be further enhanced with additional architectures, modules, and functionalities that provide, among other benefits, advanced privacy, competitive financing mechanisms, on-chain identity verification, and the creation of novel asset-backed financial instruments. The implementations described below build upon core system for managing inventory disclosed above. In all implementations.

### Marketplace Discovery and Matching

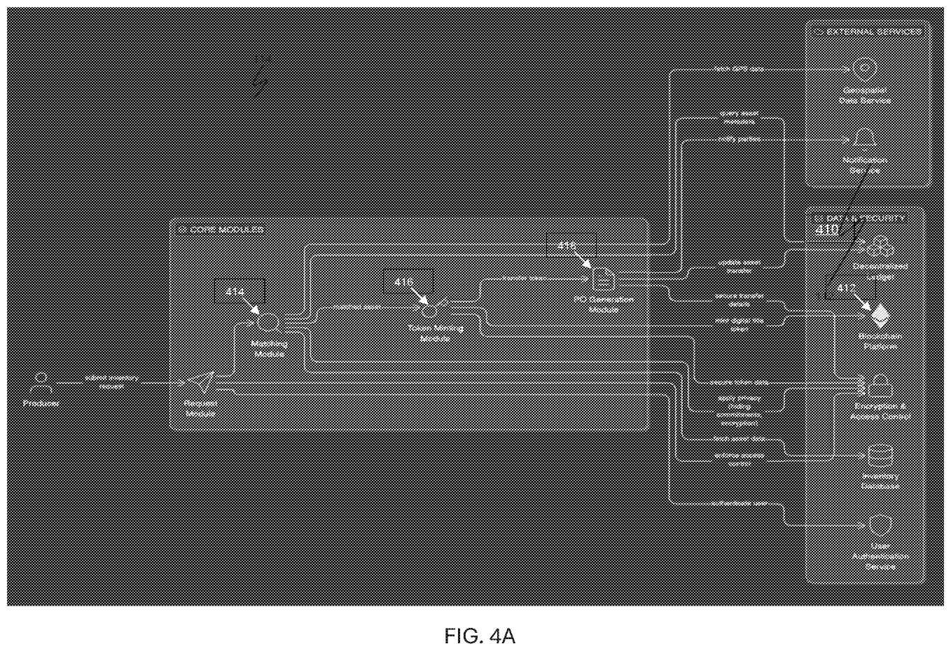

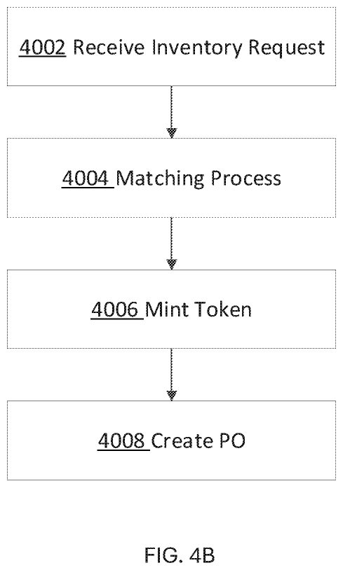

In some implementations, the system provides a decentralized marketplace for inventory discovery and matching that matches inventory requests to inventory and tokenizes the inventory for further processing while preserving the privacy of the participants. As shown in FIG. 4A, the data storage device 410 (which can be the same storage device as described above) may comprise a decentralized ledger, such as a blockchain 412, configured to store inventory data that includes a hiding commitment. A hiding commitment is a cryptographic technique used to encode sensitive asset information (such as a unique identifier, asset type, or commercial terms) privately on the ledger. By leveraging hiding commitments, only those with the proper cryptographic keys or permissions can access the underlying inventory asset information, thereby protecting the privacy and integrity of commercial transactions while maintaining transparency for authorized participants.

A matching module 414 is configured to automatically match a producer's inventory request against inventory asset metadata (such as geospatial coordinates, inventory ID, quantity and project-start-date metadata) recorded on the ledger, while preserving the privacy of the asset information via the hiding commitment. Upon a successful match, a token minting module 416 is configured to generate a unique digital token, such as a non-fungible token (NFT), representing the recordation of title for the specific, matched inventory. This token is stored on the ledger and serves as a digital twin of the physical inventory assets.

The operational flow begins when a producer submits an inventory request. The matching module 414 queries the inventory database of data storage device 410 to identify available assets. By comparing the request metadata against the on-chain inventory data, the matching module 414 can find a suitable match between the request and inventory. During this process, the hiding commitment ensures that sensitive commercial details of the inventory assets are not publicly exposed. Upon identifying a successful match, the system proceeds by having the token minting module 116 generate the unique digital token to initiate the title recordation and financing process.

Technical implementations of the token minting module 414 can vary based on the platform and the system architecture. One example is a smart contract deployed on a blockchain such as Ethereum, which automatically generates a new non-fungible token (NFT) representing the matched inventory. The smart contract receives asset metadata (e.g., inventory ID, geospatial coordinates, quantity, project start date) and, upon validation, mints a unique NFT with this metadata embedded.

Another implementation could use a permissioned blockchain, where the token minting module operates as a microservice interfacing with the ledger. The module receives a match notification, securely accesses asset metadata, and invokes ledger APIs to create a unique token. This token is then linked to the inventory record and assigned to the appropriate title holder, with access and update controls managed by cryptographic keys or permissions.

A third technical approach involves integrating with existing enterprise resource planning (ERP) systems. Here, the token minting module acts as a bridge, extracting inventory data from ERP, packaging it into a blockchain-compatible format, and minting a digital token on the ledger. This allows seamless real-time updates and status tracking between physical and digital assets, supporting workflows like shipment, receipt, and conditional ownership transfer.

The token minting module 414 can be configured to support additional security features such as privacy-preserving cryptographic commitments, multi-signature authorization, and automated compliance checks, ensuring secure and accurate title recordation and financing initiation.

Once the token is minted it is stored on the decentralized ledger and a PO generation module 418 can generate a purchase order (PO) based on the token and metadata. The PO can specify the delivery location and the initial title holder. The PO can be used to notify the parties of the inventory match and the corresponding token and to update asset transfer data and generate secure transfer details.

The PO generation module 418 utilizes the token's metadata to create a PO that formalizes the transaction between the parties. The PO can include essential details such as the inventory ID, quantity, project start date, and other commercial terms embedded in the token, ensuring that the physical asset and its digital representation are tightly linked. This process enables automated and auditable creation of purchase orders directly from the blockchain (or other decentralized ledger), facilitating seamless settlement and reducing manual reconciliation.

The generated PO can then be used to trigger downstream processes, such as shipment scheduling, payment initiation, and compliance checks. By leveraging smart contracts and the token, the PO generation module 418 can ensure that all contractual conditions are met before the PO is finalized, enhancing transparency and trust among participants. Additionally, the PO can serve as a document for both financial and logistical workflows, providing a verifiable record of the transaction that can be referenced throughout the asset's lifecycle.

The token acts as a digital twin of the inventory by mirroring essential characteristics and status updates of the physical inventory or order on the decentralized ledger. For example, when a shipment of raw materials is prepared for delivery, a token is minted that includes metadata such as the inventory ID, quantity, geospatial coordinates, and project start date. As the physical inventory moves through the supply chain—being shipped, received, or transferred—the token's metadata can be updated in real time to reflect these changes, ensuring that both the physical and digital records remain synchronized. Consider a scenario where a manufacturer receives a shipment of components. The token representing this inventory is updated to indicate “received” status, and ownership of the token is transferred to the manufacturer. This enables automated tracking, auditable title transfer, and seamless integration with workflows such as purchase order generation and compliance verification, all without exposing sensitive commercial details to unauthorized parties.

FIG. 4B illustrates an example of a method in accordance with this implementation. At 4002, an inventory request is received from a producer via the Request Module. At 4004, a matching process is executed where the matching module queries the ledger, identifies assets, using GPS metadata for example, while preserving privacy via hiding commitments. At 4006, in response to a match, the token minting module generates a unique title token representing the matched inventory. At 4008, the PO generation module creates a data structure specifying the delivery location and the initial title holder.

### Competitive Finance and Bidding

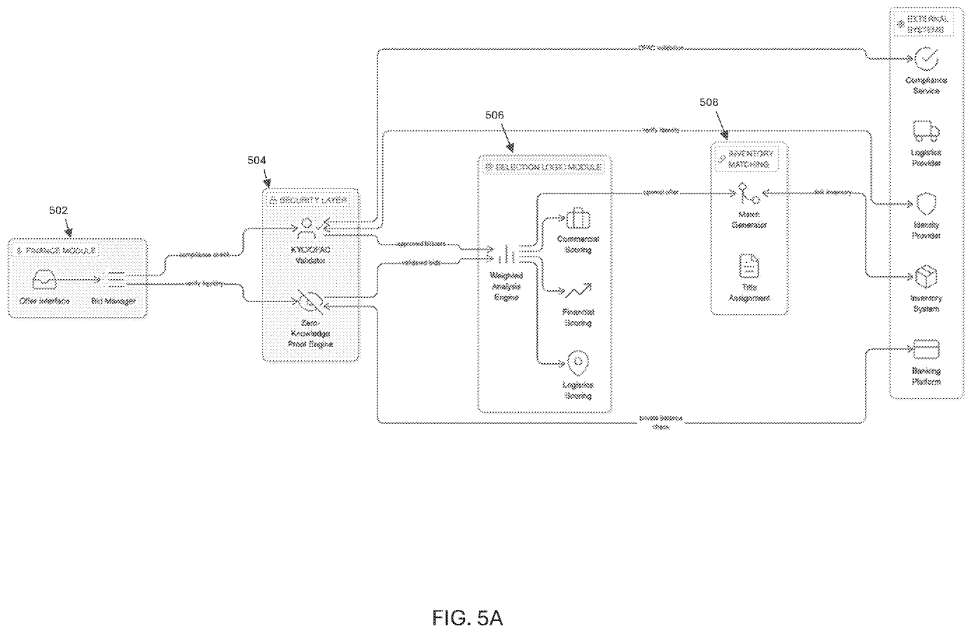

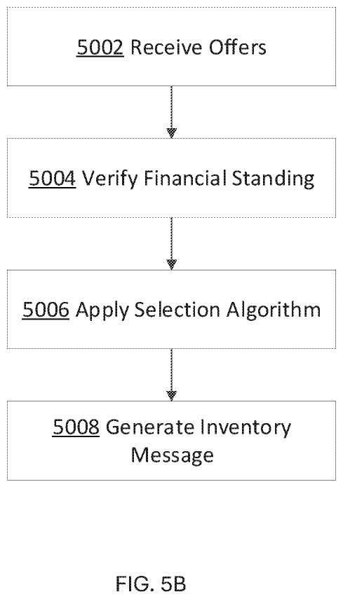

In another implementation, the system can incorporate a competitive and private bidding environment for financing the inventory. As shown in FIG. 5A, a finance module 502 provides a multi-party interface configured to receive competing offers from a plurality of potential title holders who wish to fund the purchase and hold title to a specific inventory asset.

Technical implementations of the finance module can vary depending on the platform and integration requirements. One example involves deploying the finance module as a smart contract on a blockchain such as Ethereum. In this case, the finance module 502 exposes on-chain functions for submitting financing offers, verifying zero-knowledge proofs (ZKPs) of bidder credentials, and recording the outcome of the selection logic. The smart contract interface can include methods for offer submission, offer withdrawal, and querying the status of the bidding process, all of which can be invoked by participants via their blockchain wallets.

Alternatively, the finance module 502 may be implemented as an off-chain microservice that interacts with both the decentralized ledger and enterprise systems through RESTful APIs or gRPC endpoints, for example. In this architecture, the finance module 502 can receive offer submissions and supporting documentation from title holders through secure API calls, coordinate with a ZKP engine (discussed below) for privacy-preserving verification, and communicate the validated results to the selection logic module 506. The interface can be designed for interoperability, allowing integration with web portals, mobile apps, and other enterprise modules, with authentication and authorization managed through cryptographic keys or federated identity services.

The finance module 502 may also include a user-facing dashboard that enables participants to view open inventory opportunities, track the status of their offers, and receive notifications regarding offer selection or compliance requirements. The dashboard interfaces with the underlying smart contract or microservice via secure web sockets or API calls, providing real-time updates and ensuring that all interactions are logged for auditability and regulatory compliance.

The system can include a security layer 504 that can incorporate a Zero-Knowledge Proof (ZKP) engine, which is a cryptographic module configured to validate that a bidding title holder has sufficient liquidity to fund their respective offer. This validation is performed without the bidder needing to reveal the total value of their asset pool to the ledger or other participants, thus ensuring financial privacy. A selection logic module 506, which may include an automated weighted analysis engine/algorithm which is configured to automatically evaluate the validated offers based on a combination of commercial, financial, and logistics variables to select the optimal offer.

Technical implementations of the security layer 504 and its Zero-Knowledge Proof (ZKP) module can vary depending on the platform architecture and integration requirements. One approach is to deploy the ZKP engine as a smart contract on a blockchain platform such as Ethereum. In this setup, the security layer exposes on-chain functions that allow bidding title holders to submit cryptographic proofs demonstrating their liquidity. For example, bidders generate a ZKP off-chain—using libraries like zkSNARKs or zk-STARKs—that proves they meet the required financial threshold without revealing the underlying asset values. The smart contract then verifies these proofs on-chain, ensuring that only bidders with validated credentials can participate in the bidding process.

Alternatively, the ZKP module can be implemented as an off-chain microservice that interacts with both the decentralized ledger and enterprise systems via secure APIs. In this architecture, bidders submit their liquidity proofs to the microservice, which coordinates with a ZKP verification engine to validate the proofs before communicating the results to the selection logic module. This allows for greater flexibility and integration with existing enterprise systems, such as web portals or mobile apps, while maintaining privacy and security through cryptographic validation.

The validation process typically involves the bidder preparing a proof that asserts sufficient liquidity (for example, “I have at least $1 million in assets”) without revealing the actual asset pool composition or total value. The proof is then submitted either to the blockchain or to an off-chain verifier, which checks its correctness and logs the outcome. Only bidders with successful validation are allowed to proceed to the selection phase, ensuring that financial privacy is preserved while maintaining robust security standards.

The workflow for competitive financing can be initiated after an inventory asset is matched. Multiple potential title holders can submit their offers to fund and hold title to the asset(s), e.g., inventory assets represented by the tokens described above, via the finance module 502. The ZKP engine privately verifies the financial standing of each bidder by leveraging cryptographic zero-knowledge proof protocols. For example, a bidder generates a proof, using technologies such as zkSNARKs or zk-STARKs, that asserts they possess sufficient liquidity (for example, “I have at least $1 million in assets”) without disclosing the actual asset pool details or total value. This proof is created off-chain and then submitted either to a blockchain-based smart contract or to an off-chain verification microservice, depending on the system architecture.

Once submitted, the ZKP engine validates the proof by checking its mathematical correctness and confirming that it meets the required financial threshold. The engine logs the outcome and communicates the result to the selection logic module, which determines whether the bidder is eligible to participate in the financing process. Only bidders who successfully pass this validation can proceed, ensuring robust financial privacy and security-no sensitive financial information is exposed to other participants or the decentralized ledger.

The ZKP engine may operate as a blockchain smart contract, exposing on-chain functions for proof submission and verification, or as an off-chain microservice that interacts with enterprise systems via secure APIs. In either case, the validation process is designed to preserve financial confidentiality while maintaining trust and compliance within the bidding environment.

The selection logic module 506 then applies an algorithm to the pool of ZKP-validated offers to select the best one. This algorithm can evaluate each offer against a predefined set of criteria, such as commercial terms (e.g., interest rate, payment terms), financial variables (e.g., offer amount, risk profile), and logistics factors (e.g., delivery timelines, asset location). Each criterion can be assigned a specific weight based on its relative importance to the overall selection objective. For example, financial stability might be weighted more heavily than logistics speed in certain scenarios. The algorithm can compute a composite score for each offer by multiplying the value of each criterion by its assigned weight and summing the results. The offer with the highest composite score can be identified as the optimal selection. Finally, a matched inventory message is generated by a match generator of inventory matching module 508, linking the specific inventory to the selected title holder's funding, and the process moves to generating a purchase order.

Once the top offer is chosen, a matched inventory message is generated, linking the specific inventory asset to the selected title holder's funding offer. This message serves as a confirmation that the inventory and funding have been paired successfully, and it is passed to the next stage of the workflow, which involves generating a purchase order through the PO Generation Module described above. This structured process ensures that the selection is both fair and transparent, leveraging objective, weighted criteria while maintaining the privacy and security provided by the ZKP validation process.

FIG. 5B illustrates a method in accordance with this implementation. At 5002, offers to fund and hold title to a specific inventory asset are received from multiple title holders. At 5004, the ZKP engine verifies the financial standing of each bidder privately. At 5006, the selection logic module applies a weighted algorithm to select the best offer. At 5008, A matched inventory message is generated, linking the inventory to the selected title holder's funding.

### Smart Contract-Based Identity and Settlement

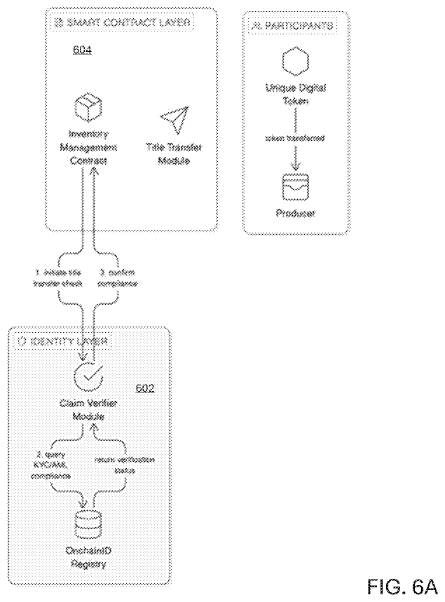

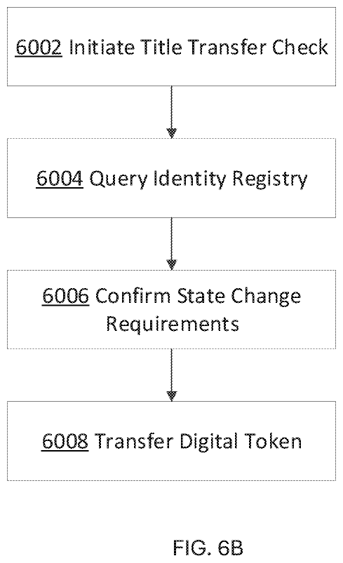

Other implementations include a smart contract-based identity and settlement layer. As shown in FIG. 6A, an identity layer 602 can include an on chain identity registry contract that may be stored on the decentralized ledger and configured to map blockchain wallet addresses to verified on-chain identities (OnchainID). This registry stores associated claims (i.e., certificates) for each identity, such as Know Your Customer (KYC) status, residency, or other credentials. A claim verifier module of the identity layer 602 is configured to execute in response to a title transfer request. This module queries the identity registry to determine if the producer's identity possesses the trusted validation certificates required by the governing inventory management contract. An inventory tracking module (described in detail above in connection with other implementations) of smart contract layer 604 includes an inventory management contract that is configured to track a physical state change of the specific inventory and to update the inventory's status on the ledger. A title transfer module (also described in detail above in connection with other implementations) of smart contract layer 604 acts as a final gatekeeper, configured to transfer the unique digital token from the title holder to the producer only if the claim verifier module returns a successful verification status.

The settlement workflow is triggered when the system initiates a title transfer check, typically in response to a physical event detected by the inventory tracking module. The claim verifier module queries the on-chain identity registry to ensure the producer is compliant with all required KYC/AML rules. Concurrently, the inventory management smart contract confirms that all conditions for transfer, such as the physical state change, have been met. Only after receiving successful verification from both the claim verifier and the smart contract does the title transfer module execute the transfer by moving the corresponding unique digital token to the producer's wallet.

FIG. 6B illustrates a method in accordance with this implementation. At 6002, the system initiates a title transfer check through the smart contract. At 6004, The claim verifier queries the identity registry to ensure the recipient is compliant with KYC/AML rules. At 6006, the smart contract calculates fees and confirms that the physical state change requirements for transfer are met. At 6008, the title transfer module transfers the unique digital token to the producer.

### Blockchain Tokenization and Title Transfer

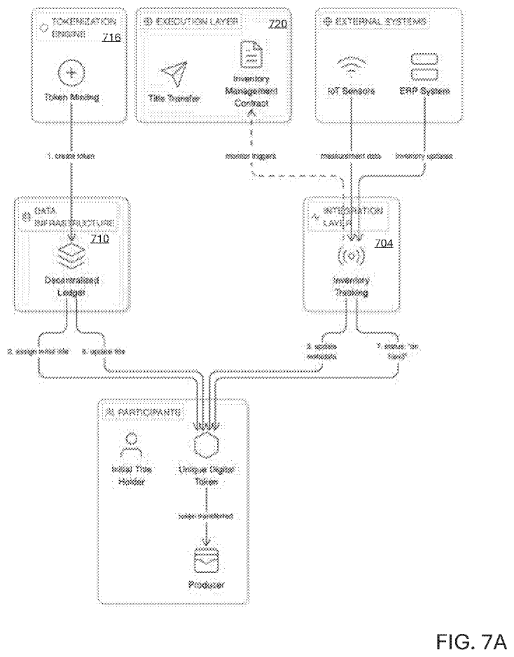

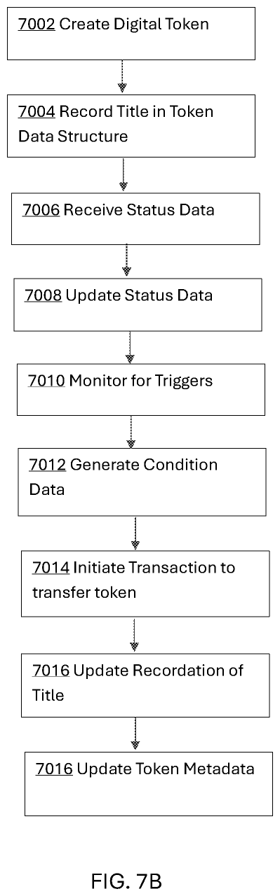

The system architecture for blockchain tokenization can be designed as a multi-layered decentralized environment. As shown in FIG. 7A, the architecture can include a Data Infrastructure Layer 710 which can include the memory device described above (including the decentralized ledger), a tokenization engine 716 (which can be the token minting module described above), a real-time Integration Layer 704 (which can include the inventory tracking module), and a conditional execution Layer 720 (which can include the title transfer module). This architecture creates a robust digital twin of the physical asset.

The operational flow begins when the tokenization engine 716 creates a unique digital token on the decentralized ledger, with title initially assigned to a title holder. As the physical inventory moves, the real-Time integration layer 704 receives status data (e.g., “shipped,” “received”) from sources like IoT sensors or ERP systems and updates the token's metadata in substantially real-time. The status may be recorded as “conditionally on-hand” while the title holder owns the token. The conditional execution layer 720 continuously monitors the inventory management contract for triggers. Upon satisfaction of a contract condition, the title transfer module initiates a blockchain transaction to transfer the token to the producer's wallet. Once the transfer is confirmed, the recordation of title is officially updated, and the inventory tracking module performs a final metadata update, changing the status to “on hand.”

FIG. 7B illustrates a process in accordance with this implementation. At 7002, in response to producer request being matched to a supplier asset, the token minting module creates a unique digital token on the decentralized ledger. This token is initially assigned to a title holder who is an entity different from the producer. At 7004, the recordation of title is recorded on the ledger within the token's data structure, while the physical inventory is prepared for delivery to a location accessible to the producer. At 7006, as the inventory is transported, the inventory tracking module receives status data (e.g., “shipped,” “received at location”) and updates the metadata of the unique digital token in real-time. At 7008, the status is updated by being recorded as “conditionally on-hand” while the title holder still owns the token. At 7010, the inventory management contract is continuously or periodically monitored for triggers, such as the passage of a maximum hold time, the producer accessing the secured location, or the removal of inventory. At 7012, upon satisfaction of a contract condition, the system generates condition data. At 7014, the title transfer module receives this data and initiates a blockchain transaction to transfer the unique digital token from the title holder's wallet to the producer's wallet. At 7016, once the token transfer is confirmed on the ledger, the recordation of title is officially updated to reflect the producer as the owner. At 7018, the inventory tracking module performs a final update to the token metadata, changing the status to “on hand”

### Asset-Backed Cryptocurrency and Liquidity Pools

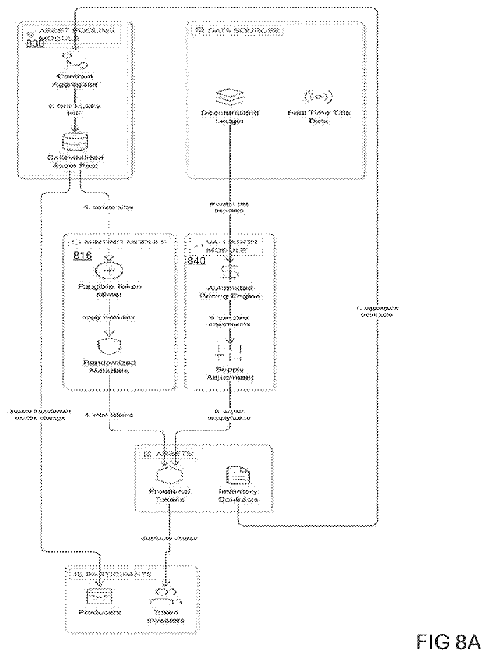

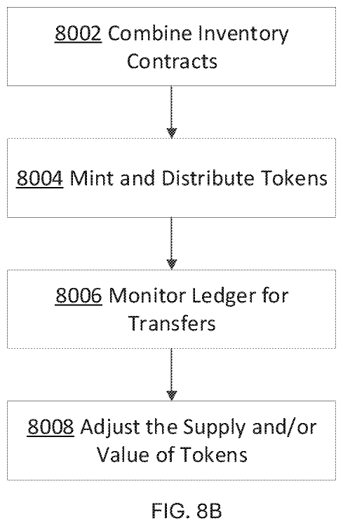

Other implementations may be configured to create novel, liquid financial instruments. As shown in FIG. 8A an asset pooling module 830 is configured to aggregate subsets of individual inventory contracts into a single collateralized pool, with pool attributes stored as randomized metadata. A minting module 816 is then configured to issue fungible digital tokens, which represent a fractional interest in the entire collateralized pool. A valuation module 840, which may be an automated pricing engine, is configured to receive real-time title status data from the ledger and automatically adjust the supply or value of the fungible tokens in response to a change in the underlying asset pool.

The workflow begins with the asset pooling module 830 combining multiple inventory contracts to form a high-value liquidity pool. The minting module 816 then issues fungible tokens representing a share of this pool, which are distributed to investors. The valuation module continuously monitors the ledger for title transfers within the pool. If an asset is removed from the pool (e.g., its title is transferred to a producer), the module automatically adjusts the supply or value of the fungible tokens to reflect the new, lower collateral level, ensuring the tokens remain accurately backed.

FIG. 8B illustrates a method in accordance with this implementation. At 8002, the asset pooling Module combines multiple inventory contracts to form a high-value liquidity pool. At 8004, fungible tokens are minted and distributed to investors, each token representing a share of the pool. At 8006, the valuation module monitors the ledger for title transfers within the pool. If assets are removed (title transferred to producers), at 8008, the module automatically adjusts the supply and/or value of the fungible tokens to reflect the new collateral level.

### Purchase Order Tokenization and B2B Settlement

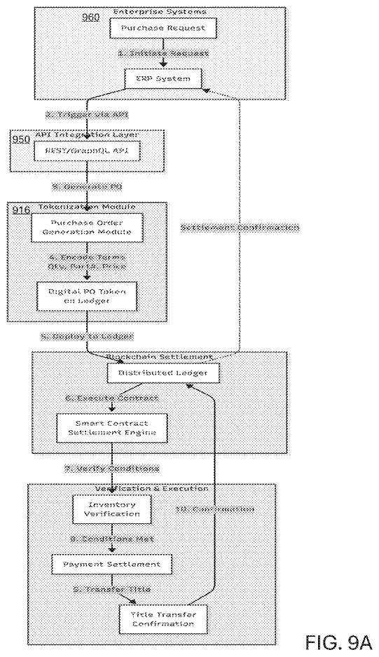

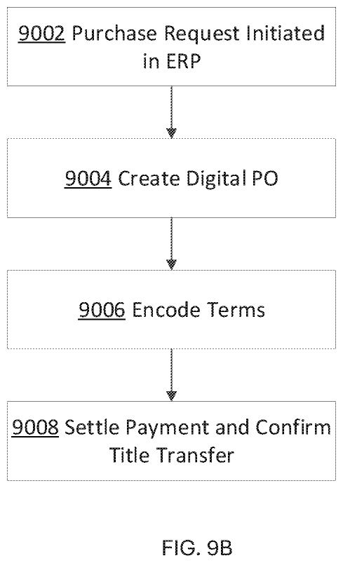

To facilitate seamless integration with existing enterprise workflows, implementations of the system can include purchase order tokenization and automated B2B settlement. As shown in FIG. 9A, an Application Programming Interface (API) integration layer 950 is configured to integrate with an external Enterprise Resource Planning (ERP) system 960. An inventory management contract module of tokenization module 916 is configured to encode the terms of a purchase order into the metadata of a digital purchase order token recorded on the decentralized ledger. A smart contract is configured to control the final settlement and payment based on the verification of inventory-related conditions.

The workflow is initiated when a producer creates a purchase request within their own ERP system. The API programmatically triggers the creation of a digital purchase order token on the ledger. The terms of the PO (e.g., quantity, price) are encoded directly into the token's metadata. The smart contract then monitors the ledger for the fulfillment of inventory-related conditions. Once these conditions are verified on-chain, the smart contract automatically settles the payment and confirms the title transfer, completing the transaction and settling the programmatic B2B interaction.

FIG. 9B illustrates a method in accordance this implementation. At 9002, a producer initiates a purchase request within their own ERP system. At 9004, the API programmatically triggers the creation of a digital purchase order token on the ledger. At 9006, PO terms (e.g., quantity, part number, price) are encoded directly into the token metadata. At 9008, the smart contract automatically settles the payment and confirms title transfer once the inventory-related conditions are verified on the ledger.

The implementations above have been described separately. However, the various elements of each implementation can be combined in an enhanced inventory management system. Further examples of technical implementations of the key modules that constitute the enhanced inventory management system, and how they cooperate with one another, are provided below.

The data storage can include a decentralized ledger and can be supported by a network of nodes. These can be deployed on cloud infrastructure (e.g., AWS EC2, Azure VMs) for scalability or on-premise servers for control. For a public network, node hardware requirements depend on the blockchain's consensus mechanism (e.g., Proof-of-Stake has lower energy requirements than Proof-of-Work). A permissioned network (Hyperledger Fabric) would require dedicated, trusted servers for participating organizations. An EVM-compatible blockchain can be used as the ledger to leverage the corresponding mature smart contract ecosystem.

An EVM-compatible blockchain can be used as the ledger to leverage the corresponding mature smart contract ecosystem. An EVM-compatible blockchain refers to a blockchain network that supports the Ethereum Virtual Machine (EVM), which is the runtime environment for executing smart contracts originally developed for the Ethereum network.

A Layer-2 scaling solution (e.g., Polygon, Arbitrum, Optimism) can be used to ensure low transaction costs and high throughput. Smart contracts can be written in Solidity. For a permissioned setting, Hyperledger Fabric with chaincode written in Go or Node.js is a viable alternative.

The nodes can communicate via the blockchain's P2P protocol. Applications interact with the ledger via JSON-RPC over HTTPS or WebSockets, often through a node provider service (e.g., Infura, Alchemy) to abstract away node management.

Inventory assets can be represented by a struct within the primary smart contract, such as:

struct InventoryAsset {
bytes32 hidingCommitment; // Keccak256(assetId, assetType, salt)
bytes32 geospatialHash; // Geohash or similar
uint256 projectStartDate;
address currentOwner;
// ... other public metadata
}

The Hiding Commitment can be a bytes32 hash generated off-chain to conceal sensitive data. The pre-image (the actual asset data) can be held privately by the asset owner. The ledger can be the primary data source. All other modules can integrate with the ledger by either sending transactions (writes) or making calls (reads) via its JSON-RPC API. Access control is enforced via cryptographic key pairs (wallets).

The matching module can be implemented as a backend microservice, which can be deployed as a containerized application (Docker) on an orchestration platform like Kubernetes. This allows for horizontal scaling based on request volume. It requires sufficient CPU and memory for efficient query processing. A high-performance backend language such as Go or Rust can be used for its concurrency and safety features. Alternatively, Node.js can be used. A blockchain interaction library like ethers.js (for Node.js) or go-ethereum (for Go) can be utilized.

The module can expose a RESTful API or a gRPC service to receive producer requests. Requests can be authenticated using JWTs or OAuth 2.0. Internally, it communicates with the blockchain ledger via JSON-RPC. An example of the data structure used for matching is set forth below”

### Producer Request (JSON):

{
“requestedAssetType”: “GRADE_A_STEEL_COIL”,
“quantity”: 100,
“deliveryLocation”: { “lat”: 40.7128, “Ion”: −74.0060 },
“requiredByDate”: “2026-12-01T00:00:00Z”
}

The matching module acts as an orchestrator. It is called by a user-facing application (e.g., a producer's dashboard, likely a microfrontend) or an API gateway. It queries the Data Storage Device and, upon finding a match, triggers the Token Minting Module. The API endpoint can be secured against unauthorized access and DDoS attacks (e.g., via rate limiting). The matching module itself only requires read access to the blockchain and does not need to store private keys.

The token minting module can be implemented as a highly secure, isolated backend microservice. It can run in a secure environment like AWS Nitro Enclaves or a virtual machine with strict firewall rules, as it manages a cryptographic key with minting privileges. Code can be written in a memory-safe language like Rust or Go. The token minting module can implement the logic to interact with an ERC-721 (NFT) smart contract deployed on the ledger. The token minting module can expose a private, internal gRPC endpoint that is only accessible by trusted services such as the matching module.

An example of the data structure used by minting module is set forth below:

Mint Request (Internal gRPC Payload):

| message MintRequest { | |
|---|---|
| string to_address = 1; | // Title Holder's wallet address |
| string metadata_uri = 2; | // IPFS URI for asset details |

}

The minting module is triggered internally by the matching module after a successful match and financing arrangement. The private key for the “minter” account can be stored in a Hardware Security Module (HSM) or a managed vault service (e.g., AWS KMS, HashiCorp Vault). Preferably, the minting module's sole responsibility should be minting to minimize its attack surface.

The finance module can be implemented as a user-facing component and a backend service. The backend service can run as a standard microservice on Kubernetes. The user-facing component can be a microfrontend built with React or Vue.js, allowing title holders to view available assets and submit bids. The backend service, written in Node.js or Go for example, manages the bidding process and interacts with the ZKP Engine. The frontend can communicate with the backend via a REST API or GraphQL. Real-time bid updates can be pushed to the frontend using WebSockets. An example data structure is set forth below:

Bid Offer (JSON):

{
“assetId”: “0x123...”,
“bidAmount”: “50000”, // In smallest currency unit
“interestRate”: “5.5”, // Annual percentage
“zkpProof”: { /* ZKP proof object */ }
}

The Zero-Knowledge Proof (ZKP) engine can be implemented as a specialized, computationally intensive service deployed on high-CPU virtual machines or even leverage serverless functions (e.g., AWS Lambda) for parallel proof generation. “High-CPU” refers to computing resources that are optimized for processing tasks requiring significant computational power. In the context of virtual machines or cloud Infrastructure, a “high-CPU” machine has many processor cores and a high clock speed, allowing it to handle complex calculations quickly and efficiently. This is especially important for services like the Zero-Knowledge Proof (ZKP) engine, which perform intensive cryptographic computations and benefit from additional CPU capacity to speed up proof generation and verification.

The ZKP engine can be built using ZKP frameworks like Circom & SnarkJS (for zk-SNARKs) or Noir. The service can have two parts: an off-chain component that generates proofs based on a bidder's private data (e.g., account balance from a private database or another blockchain), and an on-chain Verifier Smart Contract that verifies these proofs. The engine can expose an internal API (e.g., gRPC) for the Finance Module to request proof generation. A proof request can include private inputs (e.g., accountBalance) and public inputs (e.g., bidAmount) and can be implemented as a complex JSON object containing the cryptographic proof data (pi_a, pi_b, pi_dc) generated by the ZKP circuit.

The cryptographic proof data—specifically pi_a, pi_b, and pi_c—are fundamental components of a Zero-Knowledge Proof (ZKP) generated by the ZKP circuit. These values are typically arrays or structured objects that represent elements on an elliptic curve, and together they form the proof that a statement (such as a valid bid) is true without revealing any sensitive information about the bid itself. Element pi_a is usually the first part of the proof and is derived from the prover's commitment to the secret inputs. It encodes part of the cryptographic computation and is used in verifying the proof. Element pi_b is often a pair or a matrix of curve points reflecting interaction between the prover and verifier, ensuring that the computation aligns with the circuit's logic. The final element, pi_c, acts as a concluding commitment that ties together the proof, confirming the prover's claims while preserving privacy. When incorporated into a JSON object for a bid, these fields store the ZKP output, which the backend and blockchain verifier use to validate the authenticity of the bid without exposing confidential details such as the actual bid amount or bidder identity. This structure is crucial for maintaining trust, integrity, and privacy in decentralized finance applications.

The Finance Module calls this service of the ZKP engine to generate a proof for a bid. The resulting proof is then attached to the bid and sent to the on-chain verifier contract for validation. The engine should handle bidders' private financial data securely and thus should be architected to receive this data in a transient manner and never store it. The ZKP circuit itself must be audited to ensure it is sound and does not leak information.

The selection logic module can be implemented as a standard backend microservice, e.g., on Kubernetes. The logic can be written in a language suitable for complex business logic, such as Python (with data science libraries like Pandas/NumPy for analysis) or Java. It could incorporate a rules engine like Drools. The selection logic module can consume messages from a message queue (e.g., RabbitMQ, Kafka) containing validated bids or, alternatively, it can expose an internal gRPC endpoint. The selection logic module can implements an in-memory or database-backed representation of competing bids and run a weighted scoring algorithm against them, considering factors like interestRate, bidderReputation, logisticalCost, etc. It can receive a stream of validated bids from the finance module, select the best offer, and send a command to the PO generation module to proceed.

The identity registry can be implemented as a smart contract on the ledger. The verifier logic can be implemented as part of the inventory management smart contract (discussed in further detail below) to ensure atomic checks during settlement, rather than as a separate microservice which could introduce latency and failure points. The identity registry can be based on standards like ERC-725 (Identity) or a custom implementation. The identity registry can map addresses to a struct containing an array of claims. The verifier can be implemented as a function within a main contract written in Solidity. Off-chain services (like a compliance dashboard) can read from this contract using JSON-RPC, for example. On-chain, the title transfer module can call the verifier function directly. An example identity data structure is set forth below:

struct Claim {
bytes32 topic; // e.g., keccak256(“KYC_STATUS”)
bytes32 data; // e.g., “VERIFIED”
address issuer; // Wallet of the trusted issuer (e.g., compliance firm)
}

mapping(address=>Claim[ ]) public identityClaims;

A trusted, off-chain service (a “claim issuer”) can be responsible for adding verified claims to the registry.

The on-chain title transfer module can consume the verified claims data and can be implemented as a function within the inventory management smart contract running on the blockchain nodes. A function in the main Solidity contract, e.g., transferTitle(uint256 tokenId) can internally call the claim verifier and check conditions from the Inventory Tracking Module. The title transfer module can be triggered by an authorized transaction sent from the system's backend (e.g., the inventory tracking module service) upon detecting a physical state change. The title transfer function operates on the state variables of the smart contract, primarily changing the owner of the ERC-721 token representing the inventory. The title transfer module can integrate on-chain with the identity registry and can be triggered by off-chain services monitoring real-world events.

For the digital twin architecture, the inventory tracking module can be implemented as an ETL (Extract, Transform, Load) microservice pipeline. It can ingest data from various protocols (MQTT for IoT, Webhooks for ERPs), normalizes it into a standard JSON format, and submit it as a transaction to update the token metadata on the ledger. Security is crucial for authenticating data sources. For liquidity pool implementations, the asset pooling module can be a backend service with logic for creating investment pools. The minting module for fungible tokens can be another secure microservice managing an ERC-20 token contract. The valuation module can be an autonomous “keeper” or “oracle” bot, running on a scheduler (e.g., cron job in Kubernetes), that reads on-chain events and triggers supply/value adjustments.

IN B2B settlement) implementations, the API can be implemented using an API Gateway (e.g., Amazon API Gateway) which provides authentication, rate limiting, and routing to the appropriate microservices. The Digital PO Token can be another ERC-721 contract, with its metadata linking back to the inventory items it covers. The settlement smart contract ties all the logic together, executing payment transfers (e.g., in stablecoins (e.g., USDC) and title transfers atomically.

As noted above, the system can be implemented as a distributed, event-driven architecture. Backend components can be decoupled microservices communicating via APIs (e.g., gRPC for internal, REST for external) and a message bus (e.g., Kafka) for asynchronous events. This promotes flexibility and scalability, as each component can be developed, deployed, and scaled independently.

The microfrontend architecture can be leveraged for the user-facing applications. For example:
A Producer Dashboard (e.g., React microfrontend) would consume the Matching Module API to request inventory.
A Title Holder Portal (e.g., Vue microfrontend) would integrate with the Finance Module to display bidding opportunities.
An Investor Dashboard (e.g., Svelte microfrontend) would show the performance of the Asset Pooling module's fungible tokens.

These independent frontend applications can be composed at runtime inside a single application shell, allowing different teams to work on different parts of the UI simultaneously. This arrangement provides development speed and organizational scale. This modular approach, both in the backend and frontend, result in an adaptable and can evolve without requiring monolithic deployments.

The implementations discussed herein are illustrative of the present invention. As these implementations of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the implementations illustrated.

Computing systems and/or logic referred to herein can comprise an integrated circuit, a microprocessor, a personal computer, a server, a distributed computing system, a communication device, a network device, or the like, and various combinations of the same. A computing system or logic may also comprise volatile and/or non-volatile memory such as random-access memory (RAM), dynamic random access memory (DRAM), static random access memory (SRAM), magnetic media, optical media, nano-media, a hard drive, a compact disk, a digital versatile disc (DVD), optical circuits, and/or other devices configured for storing analog or digital information, such as in a database. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

The “logic” discussed herein is explicitly defined to include hardware, firmware or software stored on a non-transient computer readable medium, or any combinations thereof. The stored logic in combination with the processor is segregated herein to define functional “modules” for the purpose of description. However, each module does not necessarily correspond to discrete portions of code. This logic may be implemented in an electronic and/or digital device (e.g., a circuit) to produce a special purpose computing system. Any of the systems discussed herein optionally include a microprocessor, including electronic and/or optical circuits, configured to execute any combination of the logic discussed herein. The methods discussed herein optionally include execution of the logic by said microprocessor.

It will be appreciated by those skilled in the art that changes could be made to the implementations described above without departing from the broad inventive concept thereof. It is understood, therefore, that this invention is not limited to the implementations disclosed, but it is intended to cover modifications within the spirit and scope of the present invention as defined by the appended claims.

What is claimed:

1. A computer system for inventory management, the system comprising:
a data storage device including a decentralized ledger configured to store inventory data, the data including a hiding commitment that encodes asset information including a unique identifier, an asset type, and a hash value for a pre-image;
a matching module configured to automatically match a producer request to inventory assets by comparing request metadata against geospatial coordinates and project-start-date metadata of the inventory data recorded on the ledger;
a token minting module configured to generate a unique digital token representing the recordation of title for matched inventory, wherein the token encodes commercial variables including payment terms and maximum hold times;
a purchase order (PO) generation module configured to generate a data structure specifying delivery of the matched inventory to a producer-accessible location and transfer of the unique digital token to a title holder different from the producer;
an inventory management contract module configured to generate an inventory management contract, corresponding to the matched inventory, between the producer and the title holder, wherein the inventory management contract specifies a fee payable to the title holder for holding title to the matched inventory and at least one condition upon which title of the matched inventory will transfer from the title holder to the producer;
an inventory tracking module configured to track the specific inventory and to update a status of the matched inventory in the inventory data by transmitting updated inventory status data to the data storage device, the status being recorded as conditionally on-hand inventory of the producer while title is held by the title holder, and recorded as on hand when title is held by the producer; and
a title transfer module configured to transfer title of the matched inventory from the title holder to the producer in response to receiving condition data indicating satisfaction of the at least one condition specified in the inventory management contract.

2. The system of claim 1, wherein the unique digital token is a non-fungible token (NFT).

3. The system of claim 1, wherein the inventory tracking module is further configured to receive the updated inventory status data from an Internet-of-Things (IoT) sensor or an Enterprise Resource Planning (ERP) system.

4. The system of claim 1, wherein the at least one condition upon which title will transfer is at least one of: a passage of a designated maximum hold time, or detection of the producer accessing a secured location containing the matched inventory.

5. The system of claim 1, wherein the producer-accessible location is a warehouse or container under the physical control of the producer.

6. The system of claim 1, further comprising:
a finance module configured to receive competing ZKP-validated offers from a plurality of title holders, wherein the system validates that the title holder has sufficient liquidity to fund the purchase without revealing the total pool value to the ledger, and
a selection logic module configured to automatically select an offer based on a weighted analysis of commercial variables and transmit a matched inventory message to the purchase order generation module.

7. The system of claim 6, wherein the finance module comprises a multi-party interface for receiving the competing ZKP-validated offers.

8. The system of claim 6, wherein the weighted analysis performed by the selection logic module is based on a combination of commercial scoring, financial scoring, and logistics scoring variables.

9. The system of claim 6, further comprising a zero-knowledge proof engine configured to validate that the title holder has sufficient liquidity by generating a cryptographic proof based on a private balance of the title holder.

10. The system of claim 6, wherein the selection logic module is configured to select an offer with an optimal score determined by a weighted algorithm.

11. An inventory management system comprising:
a data storage device including a decentralized ledger configured to store inventory data, the data including a hiding commitment that encodes asset information including a unique identifier, an asset type, and a hash value for a pre-image and a recordation of title of specific inventory;
an identity registry contract stored on a decentralized ledger configured to map wallet addresses to verified on-chain identities and associated validation certificates, including KYC status and residency;
a claim verifier module configured to execute in response to a title transfer request to determine if the producer identity possesses validation certificates required by the inventory management contract;
an inventory management smart contract configured to automatically calculate an escrow title-holder fee and to generate condition data indicating that a physical state change in the inventory requires a title transfer;
a title transfer module configured to transfer the unique digital token from the title holder to the producer if the claim verifier returns a successful verification status; and
an inventory tracking module configured to track a physical state of the specific inventory and to update a status of the specific inventory in response to detection of a change in the physical state of the specific inventory by transmitting updated inventory status data to the decentralized ledger.

12. The system of claim 11, wherein the inventory tracking module is configured to detect the change in the physical state of the specific inventory using an Internet-of-Things (IoT) sensor.

13. The system of claim 11, wherein the claim verifier module is configured to determine if the producer identity possesses a valid Know Your Customer (KYC) status as one of the validation certificates.

14. The system of claim 11, wherein the identity registry contract is further configured to store validation certificates issued by a trusted third-party issuer.

15. The system of claim 11, wherein the verified on-chain identities are recorded as an OnchainID.

16. A computer system for inventory management, the system comprising:
a data storage device including a decentralized ledger configured to receive and store inventory data;
a token minting module configured to generate, on the decentralized ledger, a unique digital token for each of multiple specific inventory assets, wherein each unique digital token represents a recordation of title for the corresponding specific inventory asset;
an inventory tracking module configured to receive data indicating a physical status of the specific inventory assets and to update the status of the specific inventory assets by transmitting updated inventory status data to the decentralized ledger to update metadata of the unique digital token in real-time; and
a title transfer module configured to selectively execute a transfer of the unique digital token to transfer title of the specific inventory assets from a title holder to a producer in response to satisfaction of a condition specified in an inventory management contract.

17. The system of claim 16, wherein the system is architected into a plurality of layers, the layers comprising:
a data infrastructure layer including the decentralized ledger;
a tokenization engine including the token minting module;
a real-time integration layer including the inventory tracking module; and
a conditional execution layer including the title transfer module.

18. The system of claim 16, wherein the inventory tracking module is configured to receive the data indicating the physical status from an Internet-of-Things (IoT) sensor or an Enterprise Resource Planning (ERP) system.

19. The system of claim 16, wherein the unique digital token is a non-fungible token (NFT) that serves as a digital twin of the corresponding specific inventory asset.

20. The system of claim 16, wherein the updated inventory status data indicates a status of “conditionally on-hand” while title is held by the title holder, and a status of “on hand” after title is transferred to the producer.

21. The system of claim 16, further comprising:
an asset pooling module configured to aggregate subsets of inventory contracts into a collateralized pool, wherein the pool attributes are stored as randomized metadata to prevent third-party linkage of transaction patterns;
a minting module configured to issue fungible digital tokens representing a fractional interest in the pool;
a valuation module configured to receive real-time title status data and automatically adjust the supply of fungible tokens in response to a change in the recordation of title within the underlying asset pool.

22. The system of claim 21, wherein the valuation module comprises an automated pricing engine configured to adjust a value of the fungible tokens in response to the change in the recordation of title.

23. The system of claim 21, wherein the asset pooling module is configured to combine a plurality of inventory contracts into a high-value liquidity pool.

24. The system of claim 21, wherein the minting module is further configured to distribute the fungible digital tokens to one or more investors.

25. The system of claim 21, wherein the randomized metadata is utilized to ensure transaction privacy for the collateralized pool.

26. A computer system for decentralized purchase order execution, the system comprising:
a data storage device including a decentralized ledger;
a purchase order generation module configured to generate a purchase order including commercial, financial, and logistics terms;
an inventory management contract module configured to encode the purchase order into metadata of a digital purchase order token recorded on the decentralized ledger;
an API layer configured to integrate with an ERP system to programmatically initiate a PO and the generation of a digital purchase order token; and
a smart contract configured to encode PO terms, including quantity, part number, and payment data, into the token metadata and control settlement based on verification of inventory-related conditions recorded on the decentralized ledger.

27. The system of claim 26, wherein the API layer is configured to receive a purchase request initiated by a producer from within the producer's native ERP system.

28. The system of claim 26, wherein the digital purchase order token is a digital execution token that immutably records the commercial, financial, and logistics terms on the decentralized ledger.

29. The system of claim 26, wherein the API layer utilizes a REST or a GraphQL protocol to receive the initiation of the PO.

30. The system of claim 26, wherein the smart contract is further configured to automatically trigger a payment settlement in a digital currency upon the verification of the inventory-related conditions.

31. A computer-implemented method for inventory management, the method comprising:
storing inventory data in a data storage device including a decentralized ledger configured to store inventory data, the data including a hiding commitment that encodes asset information including a unique identifier, an asset type, and a hash value for a pre-image;
automatically matching a producer request to inventory assets by comparing request metadata against geospatial coordinates and project-start-date metadata of the inventory data recorded on the ledger;
generating a unique digital token representing the recordation of title for matched inventory, wherein the token encodes commercial variables including payment terms and maximum hold times;
generating a data structure specifying delivery of the matched inventory to a producer-accessible location and transfer of the unique digital token to a title holder different from the producer;
generating an inventory management contract, corresponding to the matched inventory, between the producer and the title holder, wherein the inventory management contract specifies a fee payable to the title holder for holding title to the specific inventory and at least one condition upon which title of the matched inventory will transfer from the title holder to the producer;
tracking the matched inventory and to update a status of the matched inventory in the inventory data by transmitting updated inventory status data to the data storage device, the status being recorded as conditionally on-hand inventory of the producer while title is held by the title holder, and recorded as on hand when title is held by the producer; and
transferring title of the matched inventory from the title holder to the producer in response to receiving condition data indicating satisfaction of the at least one condition specified in the inventory management contract.

32. A computer-implemented method for inventory management, the method comprising:
storing inventory date in a data storage device including a decentralized ledger configured to store inventory data, the data including a hiding commitment that encodes asset information including a unique identifier, an asset type, and a hash value for a pre-image and a recordation of title of specific inventory;
mapping wallet addresses to verified on-chain identities and associated validation certificates, including KYC status and residency;
executing, in response to a title transfer request, a claim verification to determine if the producer identity possesses validation certificates required by the inventory management contract;
automatically calculate an escrow title-holder fees and to generate condition data indicating that a physical state change in the inventory requires a title transfer;
transferring the unique digital token from the title holder to the producer if the claim verifier returns a successful verification status; and
tracking a physical state of the specific inventory and to update a status of the specific inventory in response to detection of a change in the physical state of the specific inventory by transmitting updated inventory status data to the decentralized ledger.

33. A computer-implemented method for inventory management, the method comprising:
receiving and storing, by a decentralized ledger, inventory data;
generating, on the decentralized ledger, a unique digital token for each of multiple specific inventory assets, wherein each unique digital token represents a recordation of title for the corresponding specific inventory asset;
receiving data indicating a physical status of the specific inventory assets and to update the status of the specific inventory assets by transmitting updated inventory status data to the decentralized ledger to update metadata of the unique digital token in real-time; and
selectively executing a transfer of the unique digital token to transfer title of the specific inventory assets from a title holder to a producer in response to satisfaction of a condition specified in an inventory management contract.

34. A computer-implemented method for decentralized purchase order execution, the method comprising:
generating a purchase order including commercial, financial, and logistics terms;
encoding the purchase order into metadata of a digital purchase order token recorded on a decentralized ledger;
integrating with an ERP system to programmatically initiate a PO and the generation of a digital purchase order token; and
encoding PO terms, including quantity, part number, and payment data, into the token metadata and control settlement based on verification of inventory-related conditions recorded on the decentralized ledger.
